(19) United States
(12) Patent Application Publication
(10) Pub. No.: US 2004/0075808 A1
(43) Pub. Date: Apr. 22, 2004

(54) Polarizing glass

(76) Inventors: Juei-Tse Lin, Xiamen (CN); Takeda Tomihiro, Xiamen (CN)

Correspondence Address: CHARLES E. BAXLEY, P.C., 59 John Street, 5th Floor, New York, NY, 10038, US

(21) Appl. No.: 10/273,602

(22) Filed: Oct. 21, 2002

(51) Int. Cl. G02C 7/10

(52) U.S. Cl. 351/163

(57) ABSTRACT

The present invention provides a polarizing glass consisted of a polarizing film and an optical substrate, wherein said polarizing film is laid on the external of internal surface of the optical substrate. Said polarizing film is coated with glue on the surface contacting with said optical substrate, and by pressing them together to form an integrated piece. Said optical substrate may be made of PA, AC, OPET or other optical material. Because the thickness of the glass can be decreased greatly to only one piece, so that the material may be saved, and the weight is reduced, simultaneously due to laying the polarizing film in front of said optical substrate, the eye sight is became more clearly and smoothly.

### BACKGROUND OF THE INVENTION

1. Field of the Invention

The present invention relates to a spectacle lens, and more particularly to a polarizing glass.

2. Description of Prior Art

In accordance with the conventional polarizing glasses, all of them, by taking the advantage of the polarization principal, are made to filter most of reflections, diffusion and glary light from the surface of objects for protecting the eyes. As shown in FIG. 1, an innovated polarizing lens of sun glasses issued in CN Patent No. 95206381.6 is consisted of two acrylic resin substrates 1 with a proper radian, bonded together with an intervening polarizing film 2 there-between. An anti-glaring glasses, issued by CN Patent No. 99218903. 9, is also consisted of two common glasses sandwiching a polarizing film. The shortcoming of them is easily to generate air bubble on the sandwiched polarizing film, and to waste material.

### OBJECTS AND SUMMARY OF THE INVENTION

It is therefore a main object of the present invention to provide a polarizing lens with lighter weight and saving material.

For archiving the goal, the present invention provides a polarizing lens consisting of an optical substrate and a polarizing film, wherein said polarizing film is attached on the external surface or internal surface of said optical substrate.

Said polarizing film is coated with glue on the surface contacting with said optical substrate.

Said optical substrate can be made of PA, AC, PC, or OPET and so on.

Said polarizing film is laid on surface of said optical substrate completely and fully.

Said polarizing film covers on a part portion of the surface of said optical substrate.

Said optical substrate can be a color-changeable.

Due to applying above-mentioned structure, said polarizing film just needs to be coated with the glue on one side, then to be stuck on the surface of said optical substrate with pressure at all. So, the thickness of the glass can be decreased greatly to only one piece, so that the material may be saved, and the weight is reduced, simultaneously due to laying the polarizing film in front of said optical substrate, the eye sight is became more clearly and smoothly.

### BRIEF DESCRIPTION OF THE DRAWINGS

FIG. 1 is an exploded solid view of the prior art.

FIG. 2 is a solid view of the present invention.

FIG. 3 is an exploded solid view of the present invention.

FIG. 4 is a sectional view of the present invention.

FIG. 5 is a sectional view showing the structure of the polarizing film of the present invention.

FIG. 6 is a solid view showing the glass laid the polarizing film on the part of the present invention.

FIG. 7 is a sectional view of FIG. 6.

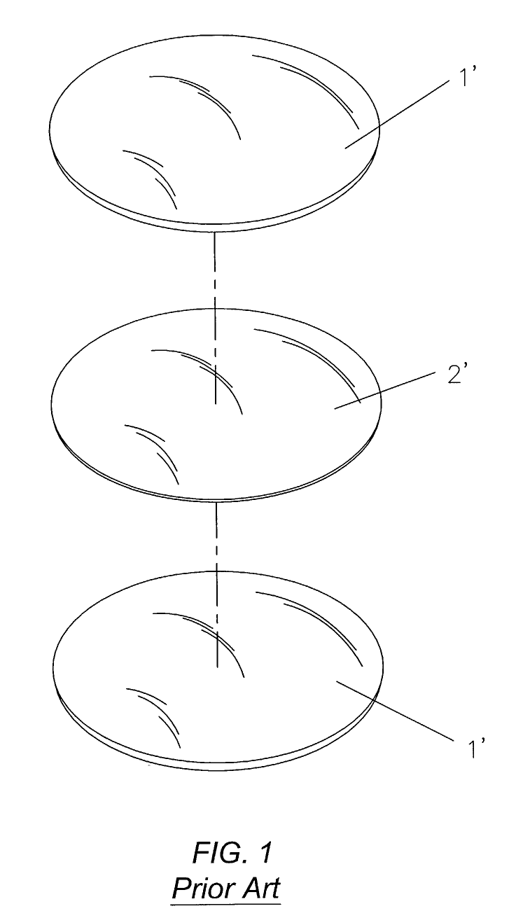

### DETAILED DESCRIPTION OF PREFERRED EMBODIMENTS

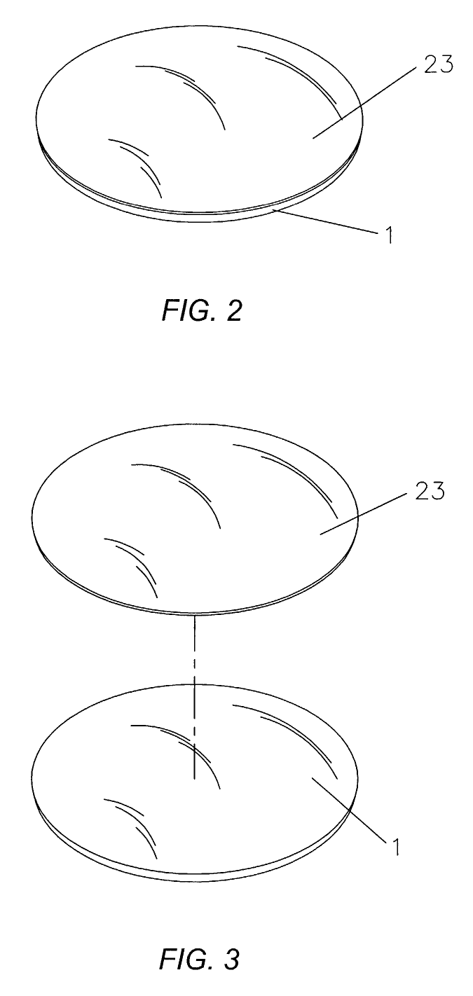

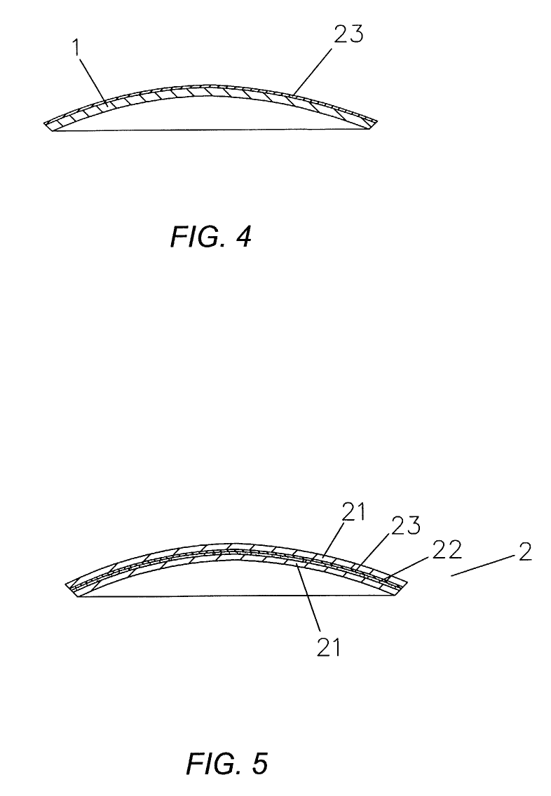

Referring to FIG. 2 to FIG. 5, a polarizing glass provided of the present invention is consisted of an optical substrate 1 with a proper radian made of PC, and a composite polarizing film 2 including four layers, from inner to outer sequentially being acetate protection film 21, glue coat 22, polarizing film 23 and acetate protection film 21, wherein said glue coat 22 is a coating layer of said polarizing film 23. Firstly, put on said composite polarizing film 2 into a die, and press forming into an integrated film with a coordinating radian to the optical substrate 1, next split the inner protection film 21 and coat glue 22 on the negative camber of said composite polarizing film 2. Then lay the polarizing film 23 on the external surface of the optical substrate 1 with the glue side contacting completely without any air between them, finally by a special equipment, press them into an integrated piece, then the external protection film 21 can be split. The outer surface of said polarizing film 3 may be treated in hard-intensifying process to prevent the surface of the film from scratching improperly.

Said composite polarizing film 2 can be stock on the internal side of the optical substrate 1.

Said optical substrate 1 in the present invention may be made of PA, AC, OPET or other optical material, and also color-changeable film.

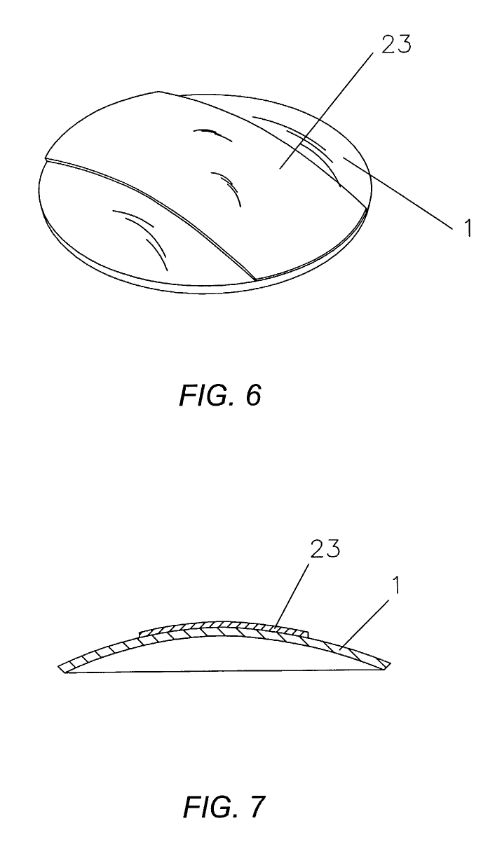

Referring to FIG. 6 and FIG. 7, the polarizing film 23 can be stock on a part of said optical substrate 1; it not only simplifies the process, but also saves more material.

I claim:

1. A polarizing glass consisted of a polarizing film and an optical substrate, wherein said polarizing film is laid on the external of internal surface of the optical substrate.

2. A polarizing glass as claimed in claim 1, wherein said polarizing film is coated with glue on the surface contacting with said optical substrate.

3. A polarizing glass as claimed in claim 1, wherein said optical substrate may be made of PA, AC, OPET or other optical material.

4. A polarizing glass as claimed in claim 1, wherein said polarizing film is contacted with surface of said optical substrate completely and fully.

5. A polarizing glass as claimed in claim 1, wherein said polarizing film just covers a part of surface of said optical substrate.

6. A polarizing glass as claimed in claim 1, wherein said optical substrate may be a color-changeable.
